(19) United States
(12) Patent Application Publication
(10) Pub. No.: US 2024/0079886 A1
(43) Pub. Date: Mar. 7, 2024

(54) ELECTRICAL STORAGE DEVICE CONTROL SYSTEM AND BACKUP POWER SUPPLY SYSTEM

(71) Applicant: Panasonic Intellectual Property Management Co., Ltd., Osaka (JP)

(72) Inventors: Kinya KATO, Aichi (JP); Yuta NAGATOMI, Osaka (JP); Masafumi NAKAMURA, Osaka (JP); Masatoshi NAKASE, Osaka (JP); Hiroki AKASHI, Osaka (JP)

(21) Appl. No.: 18/261,784

(22) PCT Filed: Dec. 27, 2021
(86) PCT No.: PCT/JP2021/048520

§ 371 Date: Jul. 17, 2023

(30) Foreign Application Priority Data
Jan. 27, 2021 (JP) 2021-011509

(51) Int. Cl. H02J 7/00

(52) U.S. Cl. CPC H02J 7/0024; H02J 7/007182; H02J 2207/10

(57) ABSTRACT

An electrical storage device control system includes a plurality of electrical storage devices and a plurality of charger circuits. The plurality of electrical storage devices are charged by a main power supply. The plurality of charger circuits are connected between the main power supply and the plurality of electrical storage devices. A mode of connection between the plurality of electrical storage devices being charged is switched to either a first connection mode or a second connection mode, depending on a voltage difference between an input voltage for the main power supply and a charging voltage based on respective voltages at the plurality of electrical storage devices. In the first connection mode, the plurality of electrical storage devices are connected together in series. In the second connection mode, the plurality of electrical storage devices are connected in parallel to the main power supply.

### TECHNICAL FIELD

The present disclosure generally relates to an electrical storage device control system and a backup power supply system including the same. More particularly, the present disclosure relates to an electrical storage device control system for controlling charging a plurality of electrical storage devices and also relates to a backup power supply system including the electrical storage device control system.

### BACKGROUND ART

Patent Literature 1 discloses a bank switching capacitor power supply device, which is designed to switch, depending on voltages of a plurality of capacitor banks, the mode of connection between a plurality of capacitor banks from series connection to parallel connection or vice versa. This bank switching capacitor power supply device charges the plurality of capacitor banks with the plurality of capacitor banks connected together in series and then sequentially charges one of the plurality of capacitor banks after another on an individual basis. Then, when the plurality of capacitor banks are all fully charged, the bank switching capacitor power supply device connects the plurality of capacitor banks to each other in parallel.

### CITATION LIST

### Patent Literature

Patent Literature 1: JP 2007-295656 A

### SUMMARY OF INVENTION

An object of the present disclosure is to provide an electrical storage device control system and a backup power supply system, each having the ability to cut down energy loss involved while a plurality of electrical storage devices are being charged.

An electrical storage device control system according to an aspect of the present disclosure includes a plurality of electrical storage devices and a plurality of charger circuits. The plurality of electrical storage devices are charged by a main power supply. The plurality of charger circuits are connected between the main power supply and the plurality of electrical storage devices. A mode of connection between the plurality of electrical storage devices being charged is switched to either a first connection mode or a second connection mode, depending on a voltage difference between an input voltage for the main power supply and a charging voltage based on respective voltages at the plurality of electrical storage devices. In the first connection mode, the plurality of electrical storage devices are connected together in series. In the second connection mode, the plurality of electrical storage devices are connected in parallel to the main power supply.

A backup power supply system according to another aspect of the present disclosure includes the electrical storage device control system described above and the main power supply.

The present disclosure enables providing an electrical storage device control system and a backup power supply system, each having the ability to cut down energy loss involved while a plurality of electrical storage devices are being charged.

### BRIEF DESCRIPTION OF DRAWINGS

FIG. 1 is a schematic circuit diagram illustrating a configuration in a first connection mode for an electrical storage device control system according to an exemplary embodiment of the present disclosure and a backup power supply system including the control system;

FIG. 2 is a schematic circuit diagram illustrating a configuration in a second connection mode for the electrical storage device control system and the backup power supply system;

FIG. 3 is a flowchart showing how the electrical storage device control system performs a charging operation;

FIG. 4 show how the voltages at a plurality of electrical storage devices change with time in the electrical storage device control system;

FIG. 5 is a schematic circuit diagram illustrating a configuration in a first connection mode for an electrical storage device control system according to a first variation and a backup power supply system including the control system;

FIG. 6 is a schematic circuit diagram illustrating a configuration in a third connection mode for the electrical storage device control system according to the first variation and the backup power supply system including the control system;

FIG. 7 is a schematic circuit diagram illustrating a configuration in a second connection mode for the electrical storage device control system according to the first variation and the backup power supply system including the control system;

FIG. 8 is a flowchart showing how the electrical storage device control system according to the first variation performs a charging operation; and

FIG. 9 show how the voltages at a plurality of electrical storage devices change with time in an electrical storage device control system according to a second variation.

### DESCRIPTION OF EMBODIMENTS

An electrical storage device control system 1 according to an exemplary embodiment of the present disclosure and a backup power supply system 2 including the electrical storage device control system 1 will now be described in detail with reference to the accompanying drawings. Note that the embodiment and its variations to be described below are only examples of the present disclosure and should not be construed as limiting. Rather, the exemplary embodiment and its variations may be readily modified in various manners depending on a design choice or any other factor without departing from a true spirit and scope of the present disclosure.

### (1) Overview

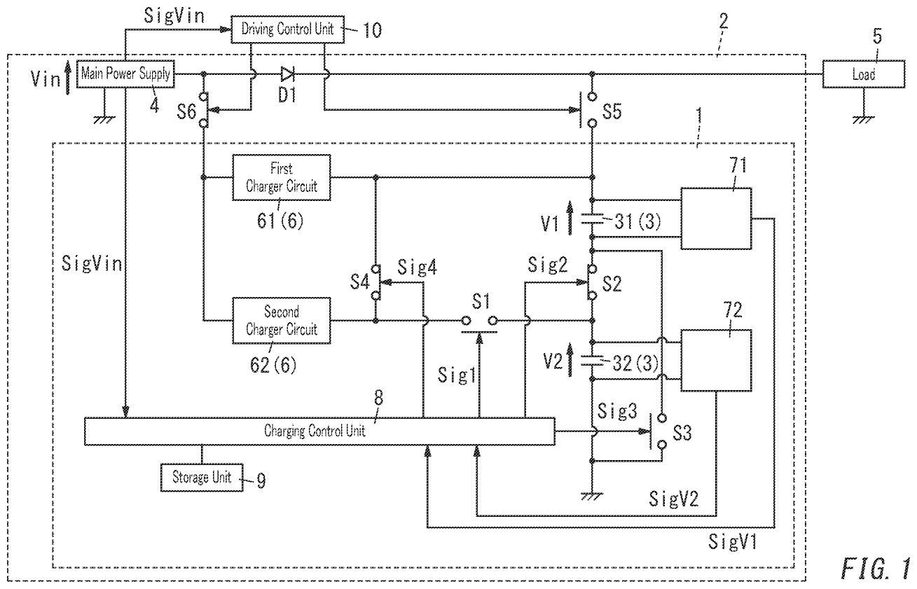

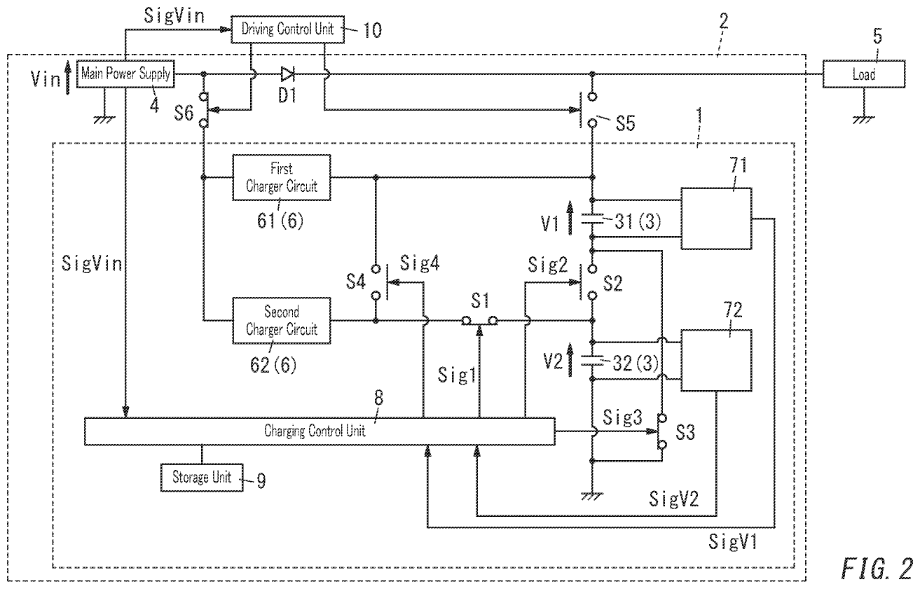

First, an overview of the electrical storage device control system 1 and backup power supply system 2 according to an exemplary embodiment will be described with reference to FIGS. 1 and 2.

As shown in FIGS. 1 and 2, the electrical storage device control system 1 is a control system for controlling charging of a plurality of electrical storage devices 3. Also, the electrical storage device control system 1 and a main power supply 4 together form a backup power supply system 2. In other words, the backup power supply system 2 includes the electrical storage device control system 1 and the main power supply 4. In this embodiment, the main power supply 4 may be a DC power supply, for example.

The electrical storage device control system 1 and the backup power supply system 2 may be installed in, for example, a moving vehicle such as an automobile and may be used as a backup power supply for a load 5 such as a braking device.

The electrical storage device control system 1 includes a plurality of (e.g., two in this embodiment) electrical storage devices 3 and a plurality of (e.g., two in this embodiment) charger circuits 6.

As shown in FIGS. 1 and 2, the plurality of (two) electrical storage devices 3 are charged by the main power supply 4 that supplies power to the load 5. Also, the plurality of (two) electrical storage devices 3 supplies power to the load 5 when the main power supply 4 causes a failure. In this embodiment, when power is supplied to the load 5, the plurality of (two) electrical storage devices 3 are connected together in series and a composite voltage of the plurality of (two) electrical storage devices 3 is applied to the load 5. Alternatively, respective voltages at the plurality of (two) electrical storage devices 3 may be applied to mutually different loads.

The plurality of (two) charger circuits 6 are connected between the main power supply 4 and the plurality of (two) electrical storage devices 3. In this case, each of the charger circuits 6 generates heat due to a difference between input and output voltages. The heat generated by the charger circuit 6 is energy to be lost without being used to charge the electrical storage device 3, out of the energy supplied from the main power supply 4 to the charger circuit 6. Thus, according to this embodiment, the mode of connection M0 between the plurality of (two) electrical storage devices 3 being charged is switched to cut down the energy loss. This enables extending the charging period in a state where there is a narrower difference between the input and output voltages of the charger circuit 6, reducing the quantity of heat generated by the charger circuit 6, and thereby cutting down the energy loss during charging, compared to a situation where the electrical storage devices 3 are charged in the single mode of connection M0.

In this embodiment, the mode of connection M0 between the plurality of (two) electrical storage devices 3 being charged is switched to either a first connection mode M1 or a second connection mode M2, depending on a voltage difference dV between the input voltage Vin for the main power supply 4 and a charging voltage Vout based on voltages at the plurality of (two) electrical storage devices 3. In this case, in the first connection mode M1, the plurality of (two) electrical storage devices 3 are connected together in series as shown in FIG. 1. On the other hand, in the second connection mode M2, the plurality of (two) electrical storage devices 3 are connected in parallel to the main power supply 4 as shown in FIG. 2.

### (2) Details

The electrical storage device control system 1 and backup power supply system 2 according to this embodiment will now be described in further detail with reference to FIGS. 1-4.

### (1) Overall Configuration

As shown in FIGS. 1 and 2, the electrical storage device control system 1 includes a plurality of (e.g., two) electrical storage devices 3 (namely, a first electrical storage device 31 and a second electrical storage device 32) and a plurality of (e.g., two) charger circuits 6 (namely, a first charger circuit 61 and a second charger circuit 62). In addition, in this embodiment, the electrical storage device control system 1 further includes two voltage detection units 71 and 72, switches S1-S4, a charging control unit 8, and a storage unit 9.

The backup power supply system 2 includes the electrical storage device control system 1 and the main power supply 4 that supplies power to the load 5. In addition, in this embodiment, the backup power supply system 2 further includes switches S5 and S6. Note that between the main power supply 4 and the load 5, provided is a backflow prevention element for preventing a current from flowing backward from the first electrical storage device 31 and the second electrical storage device 32 toward the main power supply 4. The backflow prevention element may be implemented as, for example, a diode D1.

The first electrical storage device 31 and the second electrical storage device 32 may each be implemented as an electrical double layer capacitor, for example. Alternatively, each of the first electrical storage device 31 and the second electrical storage device 32 may also be any other component that can store electricity such as a lead storage battery.

In this embodiment, the switch S5 is connected between the load 5 and a positive terminal of the first electrical storage device 31, When the main power supply 4 causes a failure, the switch S5 is turned ON to allow the first electrical storage device 31 and the second electrical storage device 32 to supply power to the load 5. Note that when supplying power to the load 5, the first electrical storage device 31 and the second electrical storage device 32 are in the first connection mode M1 (i.e., connected together in series). In this embodiment, the switch S5 may be a semiconductor switch, for example, and has its ON/OFF states controlled by a driving control unit 10. The driving control unit 10 is connected to the main power supply 4 and receives, from the main power supply 4, a signal SigVin representing the input voltage Vin for the main power supply 4. This allows the driving control unit 10 to detect the input voltage Vin for the main power supply 4 and thereby control the switch S5 OFF while the main power supply 4 is causing no failure and control the switch S5 ON upon detecting any failure in the main power supply 4.

The first electrical storage device 31 and the second electrical storage device 32 are charged by the main power supply 4. In this embodiment, the switch S6 is connected between the main power supply 4 and the first charger circuit 61 and the second charger circuit 62. In this embodiment, the switch S6 may be, for example, a semiconductor switch and has its ON/OFF states controlled by the driving control unit 10. When the driving control unit 10 controls the switch S6 ON, the input voltage Vin is supplied from the main power supply 4 to the first charger circuit 61 and the second charger circuit 62. As a result, currents are supplied from the first charger circuit 61 and the second charger circuit 62 to the first electrical storage device 31 and the second electrical storage device 32, thus charging the first electrical storage device 31 and the second electrical storage device 32. Note that although the driving control unit 10 is provided in this embodiment separately from the backup power supply system 2, the driving control unit 10 may also be one of constituent elements of the backup power supply system 2.

Each of the first charger circuit 61 and the second charger circuit 62 is a dropper circuit, which is a stabilizer circuit of a dropper type. Optionally, each of the first charger circuit 61 and the second charger circuit 62 may further include a circuit other than the dropper circuit (e.g., may include a circuit consisting of resistors). In other words, the first charger circuit 61 and the second charger circuit 62 are two circuits, each including a dropper circuit. As shown in FIGS. 1 and 2, the first charger circuit 61 is provided between the main power supply 4 and the positive terminal of the first electrical storage device 31 and supplies a current, of which the current value is equal to or less than a predetermined current value, to the first electrical storage device 31. On the other hand, the second charger circuit 62 is provided between the main power supply 4 and the positive terminal of the second electrical storage device 32 and supplies a current, of which the current value is equal to or less than a predetermined current value, to the second electrical storage device 32. That is to say, the first charger circuit 61 and the second charger circuit 62 are provided in parallel with the main power supply 4.

The voltage detection units 71 and 72 detect the voltages at the first electrical storage device 31 and the second electrical storage device 32, respectively. The voltage detection unit 71 is connected to positive and negative terminals of the first electrical storage device 31 to detect a voltage V1 at the first electrical storage device 31. The voltage detection unit 72 is connected to positive and negative terminals of the second electrical storage device 32 to detect a voltage V2 at the second electrical storage device 32. In addition, the voltage detection units 71 and 72 output signals SigV1 and SigV2, respectively representing the voltages V1 and V2 detected at the first electrical storage device 31 and the second electrical storage device 32, to the charging control unit 8 (to be described later).

Each of the switches S1-S4 may be a semiconductor switch, for example, and has its ON/OFF states controlled by the charging control unit 8 (to be described later). The switch S1 is provided between the output terminal of the second charger circuit 62 and the positive terminal of the second electrical storage device 32. The switch S2 is provided between the negative terminal of the first electrical storage device 31 and the positive terminal of the second electrical storage device 32. The switch S3 is provided between the negative terminal of the first electrical storage device 31 and a reference potential. In addition, the switch S3 is provided in parallel with the switch S2 and the second electrical storage device 32 that are connected together in series. That is to say, the negative terminal of the second electrical storage device 32 is connected to the reference voltage. The switch S4 is provided between the output terminal of the first charger circuit 61 and the output terminal of the second charger circuit 62. Optionally, a backflow prevention switch may be further provided between the output terminal of the first charger circuit 61 and the positive terminal of the first electrical storage device 31. Controlling the backflow prevention switch OFF may prevent currents from flowing backward from the first electrical storage device 31 and the second electrical storage device 32 toward the first charger circuit 61 and the second charger circuit 62 while power is being supplied from the first electrical storage device 31 and the second electrical storage device 32 to the load.

The charging control unit 8 is connected to the main power supply 4 and receives the signal SigVin, representing the input voltage Vin for the main power supply 4, from the main power supply 4. In addition, the charging control unit 8 is also connected to the voltage detection units 71 and 72 and receives the signals SigV1 and SigV2, representing the respective voltages V1 and V2 at the first electrical storage device 31 and the second electrical storage device 32, from the voltage detection units 71 and 72, respectively. Furthermore, the charging control unit 8 is further connected to the switches S1-54 to control, based on the input voltage Vin and the voltages V1 and V2, the ON/OFF states of the switches S1-S4 in accordance with control signals Sig1-Sig4, respectively.

The charging control unit 8 includes, as a major constituent element, a computer system including a memory and a processor. The functions of the charging control unit 8 are performed by making the processor execute a program stored in the memory of the computer system. The program may be stored in advance in the memory. Alternatively, the program may also be downloaded via a telecommunications line such as the Internet or distributed after having been stored in a non-transitory storage medium such as a memory card.

The storage unit 9 is connected to the charging control unit 8. The storage unit 9 stores, for example, preset voltage values to be referred to by the charging control unit 8, which is controlling, based on the input voltage Vin and the voltages V1 and V2, the ON/OFF states of the switches S1-S4.

The storage unit 9 includes a rewritable nonvolatile memory such as an electrically erasable programmable read-only memory (EEPROM) or a flash memory. Note that the preset voltage or any other setting may be stored in the charging control unit 8. That is to say, the storage unit 9 is not an essential constituent element for the electrical storage device control system 1 but may be omitted as appropriate.

### (2.2) Charging Operation

Next, it will be described in detail with reference to FIGS. 1-4 how the electrical storage device control system 1 according to this embodiment performs the operation of charging the first electrical storage device 31 and the second electrical storage device 32.

(2.2.1) Charging Operation in First Connection Mode

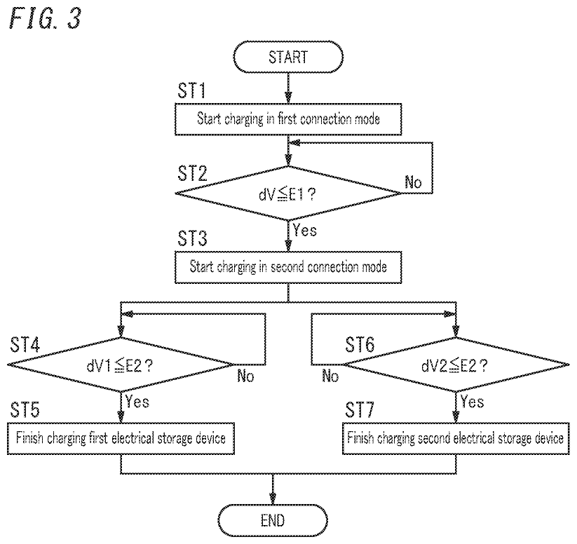

As shown in FIG. 1, in the first connection mode M1 in which the first electrical storage device 31 and the second electrical storage device 32 are connected together in series, the first charger circuit 61 and the second charger circuit 62 start charging the first electrical storage device 31 and the second electrical storage device 32 (in ST1 shown in FIG. 3).

Specifically, making the charging control unit 8 control the switches S1 and S3 OFF and the switches S2 and S4 ON turns the first electrical storage device 31 and the second electrical storage device 32 into the first connection mode M1. Then, when the driving control unit 10 turns the switch S6 ON, the first charger circuit 61 and the second charger circuit 62 start charging the first electrical storage device 31 and the second electrical storage device 32 in the first connection mode M1.

In the first connection mode M1, the first charger circuit 61 and the second charger circuit 62 are connected in parallel between the main power supply 4 and the first electrical storage device 31 and second electrical storage device 32 that are connected together in series as shown in FIG. 1. In other words, the respective input terminals of the first charger circuit 61 and the second charger circuit 62 are connected to the main power supply 4, and the respective output terminals of the first charger circuit 61 and the second charger circuit 62 are connected to the positive terminal of the first electrical storage device 31. Then, the first electrical storage device 31 and second electrical storage device 32 in the first connection mode M1 are charged with currents supplied from the first charger circuit 61 and the second charger circuit 62, respectively. In this case, if the voltage difference dV between the input voltage Vin and the charging voltage Vout (V1+V2), which is a composite voltage of the voltages V1 and V2, is greater than a first preset value E1 (i.e., if the answer is NO in ST2 shown in FIG. 3), then the first charger circuit 61 and the second charger circuit 62 continue charging in the first connection mode M1.

### (2.2.2) Charging Operation in Second Connection Mode

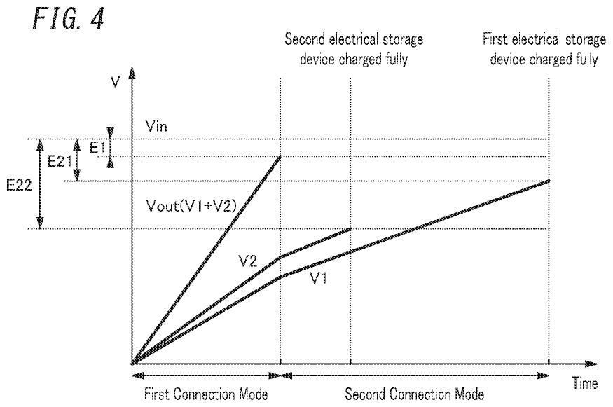

When the voltage difference dV between the input voltage Vin and the charging voltage Vout (V1+V2) that is the composite voltage of the voltages V1 and V2 becomes equal to or less than the first preset value E1 (i.e., if the answer is YES in ST2 shown in FIG. 3) as shown in FIG. 4 with the progress of charging in the first connection mode M1, the first charger circuit 61 and the second charger circuit 62 start charging in the second connection mode M2 (in ST3 shown in FIG. 3).

In this embodiment, supposing E1=0.5 V and Vin=12 V, for example, when the charging voltage Vout becomes equal to or higher than 11.5 V, the voltage difference dV becomes equal to or less than 0.5 V and the mode of connection M0 between the first electrical storage device 31 and the second electrical storage device 32 is switched from the first connection mode M1 to the second connection mode M2.

The switch from the first connection mode M1 to the second connection mode M2 is made by the charging control unit 8. The charging control unit 8 derives the voltage difference dV between the input voltage Vin and the charging voltage Vout at predetermined intervals (of 1 second, for example). At a point in time when the voltage difference dV becomes equal to or less than 0.5 V, the charging control unit 8 switches the first electrical storage device 31 and the second electrical storage device 32 to the second connection mode M2 by controlling the ON/OFF states of the switches S1-S4. Specifically, when the switches S1 and S3 are controlled ON and the switches S2 and S4 are controlled OFF by the charging control unit 8, the first electrical storage device 31 and the second electrical storage device 32 turn into the second connection mode M2 as shown in FIG. 2.

In this embodiment, the first charger circuit 61 and the second charger circuit 62 are provided for the first electrical storage device 31 and the second electrical storage device 32, respectively. In the second connection mode M2, the first electrical storage device 31 and second electrical storage device 32 are charged with currents supplied from their associated first charger circuit 61 and second charger circuit 62, respectively. Thus, in the second connection mode M2, the respective charging periods of the first electrical storage device 31 and the second electrical storage device 32 overlap with each other at least partially. That is to say, in the second connection mode M2, the first electrical storage device 31 and the second electrical storage device 32 may be charged simultaneously. This enables shortening the charging time compared to sequentially charging the first electrical storage device 31 and the second electrical storage device 32 using a single charger circuit.

When voltage differences dV1 and dV2 between the input voltage Vin and the respective voltages V1 and V2 at the first electrical storage device 31 and the second electrical storage device 32 become equal to or less than a second preset value E2 (if the answer is YES in ST4 and if the answer is YES in ST6 shown in FIG. 3), the first charger circuit 61 and the second charger circuit 62 finish charging the first electrical storage device 31 and the second electrical storage device 32 (in ST5 and ST7 shown in FIG. 3). More specifically, the charging control unit 8 derives the voltage difference dV1 between the input voltage Vin and the voltage V1 at the first electrical storage device 31 and the voltage difference dV2 between the input voltage Vin and the voltage V2 at the second electrical storage device 32 at predetermined intervals (of 1 second, for example). At a point in time when the voltage differences dV1 and dV2 become equal to or less than the second preset value E2, the charging control unit 8 instructs the first charger circuit 61 and the second charger circuit 62 to finish charging the electrical storage devices 31 and 32, respectively, by controlling the ON/OFF states of the switches S1-S4 as shown in FIG. 4. In this embodiment, the second preset value E2 is set at two different values E21 and E22 for the electrical storage devices 31 and 32, respectively. Alternatively, the second preset value E2 may also be set at the same value for these electrical storage devices.

In this embodiment, supposing the second preset value E21 associated with the first electrical storage device 31 is 2 V (i.e., E21=2 V) and Vin=12V, for example, when the voltage V1 becomes equal to or higher than 10 V, the voltage difference dV1 becomes equal to or less than 2 V, and the first charger circuit 61 finishes charging the first electrical storage device 31. Specifically, when the switch S3 is controlled OFF by the charging control unit 8, the first charger circuit 61 stops supplying the current to the first electrical storage device 31 to finish charging the first electrical storage device 31. Meanwhile, supposing the second preset value E22 associated with the second electrical storage device 32 is 4.5 V (i.e., E22=4.5 V), for example, when the voltage V2 becomes equal to or higher than 7.5 V, the voltage difference dV2 becomes equal to or less than 4.5 V, and the second charger circuit 62 finishes charging the second electrical storage device 32 as shown in FIG. 4. Specifically, when the switch S1 is controlled OFF by the charging control unit 8, the second charger circuit 62 finishes charging the second electrical storage device 32.

### (3) First Variation

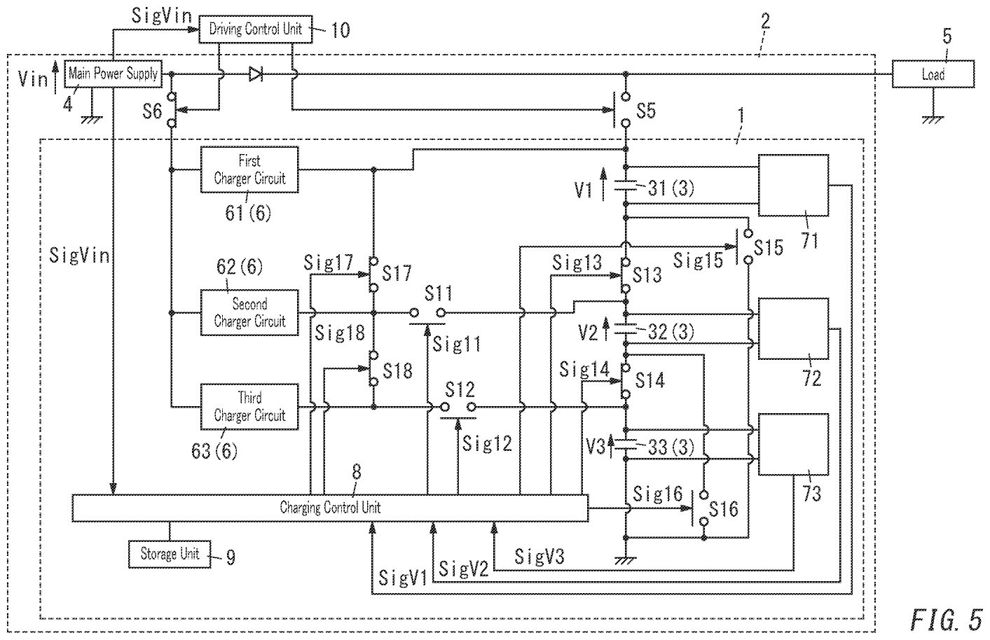

Next, an electrical storage device control system 1 according to a first variation of the exemplary embodiment will be described with reference to FIGS. 5-8. In the following description, any constituent element of this first variation, having the same function as a counterpart of the electrical storage device control system 1 according to the exemplary embodiment described above, will be designated by the same reference numeral as that counterpart's, and description thereof will be omitted herein as appropriate. Optionally, the respective constituent elements of the first variation to be described below may be adopted as appropriate in combination with respective constituent elements described for the exemplary embodiment.

The electrical storage device control system 1 according to the exemplary embodiment described above includes a plurality of (two) electrical storage devices 3 (namely, the first electrical storage device 31 and the second electrical storage device 32) and is switched to either the first connection mode M1 in which the first electrical storage device 31 and the second electrical storage device 32 are connected together in series or the second connection mode M2 in which the first electrical storage device 31 and the second electrical storage device 32 are connected in parallel to the main power supply 4.

In this first variation, the electrical storage device control system 1 includes a plurality of (three) electrical storage devices 3 (namely, the first electrical storage device 31, the second electrical storage device 32, and a third electrical storage device 33). The modes of connection M0 between the first to third electrical storage devices 31-33 further include a third connection mode M3 in which the first electrical storage device 31 and the second electrical storage device 32, belonging to the first to third electrical storage devices 31-33, are connected together in series, which is a difference from the exemplary embodiment described above. Note that according to this first variation, the first connection mode M1 is a mode of connection M0 in which the first to third electrical storage devices 31-33 are connected together in series. The second connection mode M2 is a mode of connection M0 in which the first to third electrical storage devices 31-33 are connected in parallel to the main power supply 4.

In this first variation, the mode of connection M0 between the first to third electrical storage devices 31-33 is switched from the first connection mode M1 to the third connection mode M3 and then to the second connection mode M2.

### (3.1) Overall Configuration for First Variation

The electrical storage device control system 1 according to this variation includes the first to third electrical storage devices 31-33, the first charger circuit 61, the second charger circuit 62, a third charger circuit 63, voltage detection units 71-73, switches S11-S18, and the charging control unit 8 as shown in FIGS. 5-7.

The first to third charger circuits 61-63 are provided in parallel with the main power supply 4.

The voltage detection units 71-73 detect the voltages V1-V3 at the first to third electrical storage devices 31-33, respectively. In addition, the voltage detection units 71-73 transmit signals SigV1-SigV3, respectively representing the voltages V1-V3 detected, to the charging control unit 8.

Each of the switches S11-S18 has its ON/OFF states controlled by the charging control unit 8. In this variation, each of the switches S11-S18 may be a semiconductor switch, for example. The switch S11 is provided between the output terminal of the second charger circuit 62 and the positive terminal of the second electrical storage device 32. The switch S12 is provided between the output terminal of the third charger circuit 63 and the positive terminal of the third electrical storage device 33. The switch S13 is provided between the negative terminal of the first electrical storage device 31 and the positive terminal of the second electrical storage device 32. The switch S14 is provided between the negative terminal of the second electrical storage device 32 and the positive terminal of the third electrical storage device 33. The switch S15 is provided between the negative terminal of the first electrical storage device 31 and the reference potential. In addition, the switch S15 is also provided in parallel with the switch S13, the second electrical storage device 32, the switch S14, and the third electrical storage device 33 which are connected together in series. That is to say, the negative terminal of the third electrical storage device 33 is connected to the reference voltage. The switch S16 is provided between the negative terminal of the second electrical storage device 32 and the reference potential. In addition, the switch S16 is provided in parallel with the switch S14 and the third electrical storage device 33 which are connected together in series. The switch S17 is provided between the output terminal of the first charger circuit 61 and the output terminal of the second charger circuit 62. The switch S18 is provided between the output terminal of the second charger circuit 62 and the output terminal of the third charger circuit 63. Optionally, a backflow prevention switch may be further provided between the output terminal of the first charger circuit 61 and the positive terminal of the first electrical storage device 31. Controlling the backflow prevention switch OFF may prevent currents from flowing backward from the first to third electrical storage devices 31-33 toward the first to third charger circuits 61-63 while power is being supplied from the first to third electrical storage devices 31-33 to the load.

The charging control unit 8 is connected to the main power supply 4 and receives the signal SigVin, representing the input voltage Vin for the main power supply 4, from the main power supply 4. In addition, the charging control unit 8 is also connected to the voltage detection units 71-73 and receives the signals SigV1-SigV3, representing the respective voltages V1-V3 at the first to third electrical storage devices 31-33, from the voltage detection units 71-73, respectively. Furthermore, the charging control unit 8 is further connected to the switches S11-S18 to control, based on the input voltage Vin and the voltages V1-V3, the ON/OFF states of the switches S11-S18 in accordance with control signals Sig11-Sig18, respectively.

(3.2) Charging Operation According to First Variation

Next, it will be described in detail with reference to FIGS. 5-8 how the electrical storage device control system 1 according to this first variation performs the operation of charging the first to third electrical storage devices 31-33.

### (3.2.1) Charging Operation in First Connection Mode According to First Variation

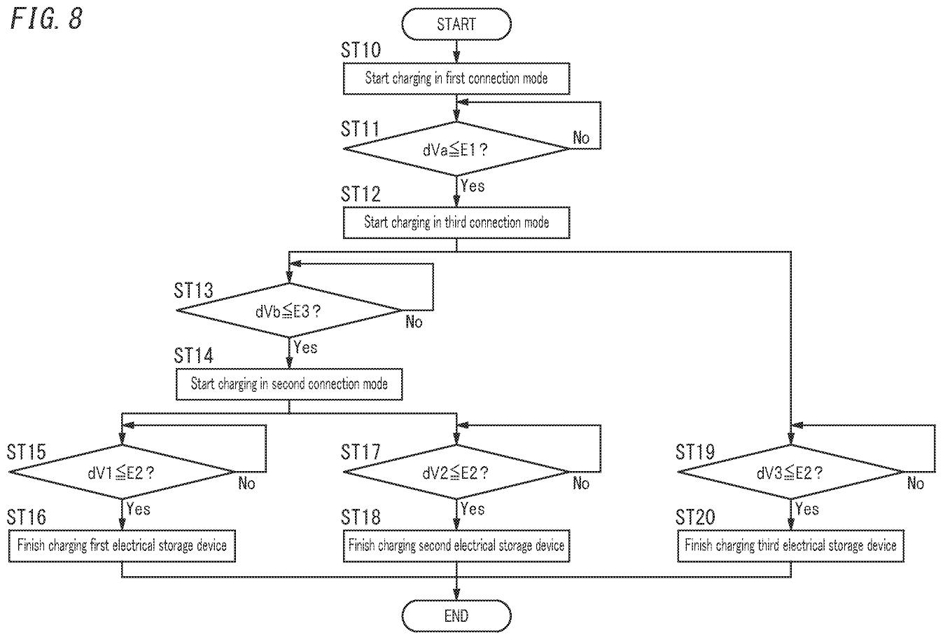

As shown in FIG. 5, in the first connection mode M1 in which the first to third electrical storage devices 31-33 are connected together in series, the first to third charger circuits 61-63 start charging the first to third electrical storage devices 31-33 (in ST10 shown in FIG. 8).

Specifically, making the charging control unit 8 control the switches S11, S12, S15, and S16 OFF and the switches S13, S14, S17, and S18 ON turns the first to third electrical storage devices 31-33 into the first connection mode M1. Then, when the driving control unit 10 turns the switch S6 ON, the first to third charger circuits 61-63 start charging the first to third electrical storage devices 31-33.

In the first connection mode M1, the first to third charger circuits 61-63 are connected in parallel between the first to third electrical storage devices 31-33 that are connected together in series and the main power supply 4 as shown in FIG. 5. In other words, the respective input terminals of the first to third charger circuits 61-63 are connected to the main power supply 4, and the respective output terminals of the first to third charger circuits 61-63 are connected to the positive terminal of the first electrical storage device 31. Then, the first to third electrical storage devices 31-33 in the first connection mode M1 are charged with currents supplied from the first to third charger circuits 61-63, respectively.

### (3.2.2) Charging Operation in Third Connection Mode According to First Variation

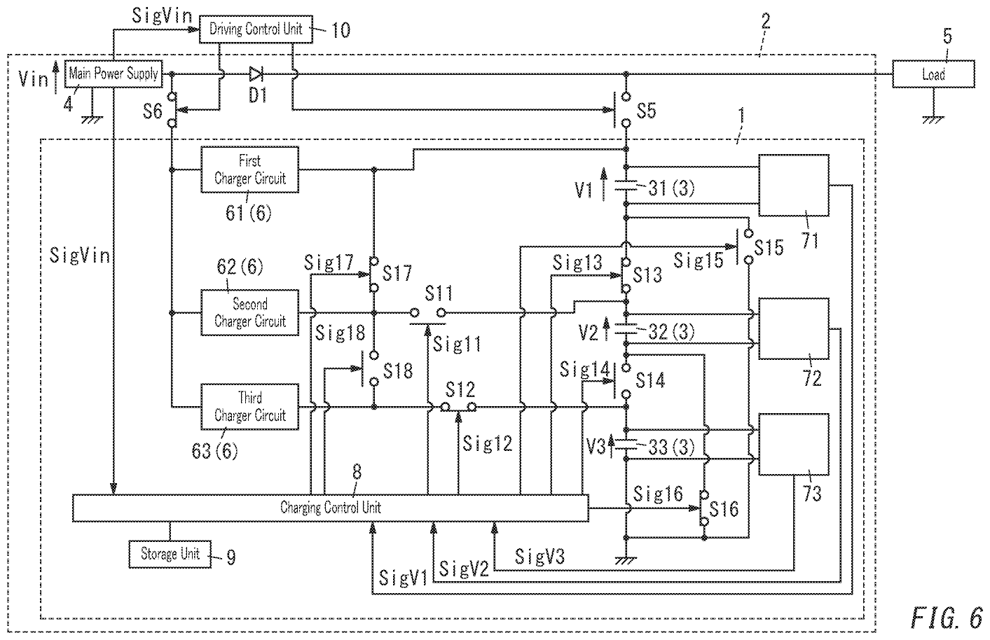

When the voltage difference dVa between the input voltage Vin and a first charging voltage Vout1 (V1+V2+V3) that is the composite voltage of the voltages V1-V3 becomes equal to or less than the first preset value E1 (i.e., if the answer is YES in ST11 shown in FIG. 8) with the progress of charging in the first connection mode M1, the first to third charger circuit 61-63 start charging in the third connection mode M3 (in ST12 shown in FIG. 8). In this first variation, the third connection mode M3 is a mode of connection M0 in which the first electrical storage device 31 and the second electrical storage device 32 are connected together in series and in which the third electrical storage device 33 is connected in parallel to the first electrical storage device 31 and the second electrical storage device 32 that are connected together in series as shown in FIG. 6. In addition, in the third connection mode M3, the first charger circuit 61 and the second charger circuit 62 are connected in parallel. That is to say, the respective input terminals of the first charger circuit 61 and the second charger circuit 62 are connected to the main power supply 4 and the respective output terminals of the first charger circuit 61 and the second charger circuit 62 are connected to the positive terminal of the first electrical storage device 31. This allows the first electrical storage device 31 and the second electrical storage device 32 that are connected together in series to be charged with currents supplied from the first charger circuit 61 and the second charger circuit 62 that are connected in parallel. Meanwhile, the third electrical storage device 33 is charged with a current supplied from the third charger circuit 63.

In this first variation, supposing E1=0.5 V and Vin=12 V, for example, when the charging voltage Vout1 becomes equal to or higher than 11.5 V, the voltage difference dVa becomes equal to or less than 0.5 V and the mode of connection M0 between the first to third electrical storage devices 31-33 is switched from the first connection mode M1 to the third connection mode M3.

The switch from the first connection mode M1 to the third connection mode M3 is made by the charging control unit 8. The charging control unit 8 derives the voltage difference dVa between the input voltage Vin and the charging voltage Vout1 at predetermined intervals (of 1 second, for example). At a point in time when the voltage difference dVa becomes equal to or less than 0.5 V, the charging control unit 8 switches the first to third electrical storage devices 31-33 to the third connection mode M3 by controlling the ON/OFF states of the switches S11-S18. Specifically, when the switches S12, S13, S16, and S17 are controlled ON and the switches S11, S14, S15, and S18 are controlled OFF by the charging control unit 8, the first to third electrical storage devices 31-33 turn into the third connection mode M3 as shown in FIG. 6.

In the third connection mode M3, the first electrical storage device 31 and the second electrical storage device 32 that are connected together in series are charged with currents supplied from the first charger circuit 61 and the second charger circuit 62 respectively, and the third electrical storage device 33 is charged with a current supplied from the third charger circuit 63. In this first variation, the first electrical storage device 31 and the second electrical storage device 32 are connected together in series in the third connection mode M3. Alternatively, the second electrical storage device 32 and the third electrical storage device 33 may be connected together in series. In that case, the first electrical storage device 31 is connected in parallel to the second electrical storage device 32 and the third electrical storage device 33 that are connected together in series.

### (3.2.3) Charging Operation in Second Connection Mode According to First Variation

When a voltage difference dVb between the input voltage Vin and a second charging voltage Vout2 (V1+V2) that is the composite voltage of the voltages V1 and V2 becomes equal to or less than a third preset value E3 (i.e., if the answer is YES in ST13 shown in FIG. 8) with the progress of charging in the third connection mode M3, the first to third charger circuit 61-63 start charging in the second connection mode M2 (in ST14 shown in FIG. 8).

In this first variation, supposing E3=0.5 V and Vin=12 V, for example, when the charging voltage Vout2 becomes equal to or higher than 11.5 V, the voltage difference dVb becomes equal to or less than 0.5 V and the mode of connection M0 between the first to third electrical storage devices 31-33 is switched from the third connection mode M3 to the second connection mode M2.

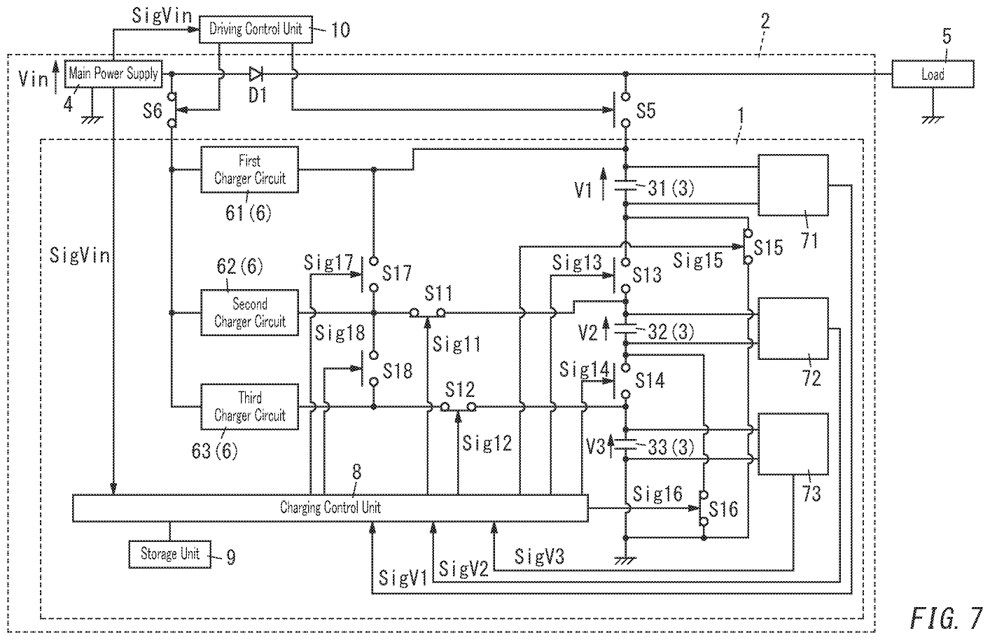

The switch from the third connection mode M3 to the second connection mode M2 is made by the charging control unit 8. The charging control unit 8 derives the voltage difference dVb between the input voltage Vin and the charging voltage Vout2 at predetermined intervals (of 1 second, for example). At a point in time when the voltage difference dVb becomes equal to or less than 0.5 V, the charging control unit 8 switches the first to third electrical storage devices 31-33 to the second connection mode M2 by controlling the ON/OFF states of the switches S11-S18. Specifically, when the switches S11, S12, S15, and S16 are controlled ON and the switches S13, S14, S17, and S18 are controlled OFF by the charging control unit 8, the first to third electrical storage devices 31-33 turn into the second connection mode M2 as shown in FIG. 7.

In this first variation, the first to third charger circuits 61-63 are provided for the electrical storage devices 31-33, respectively. In the second connection mode M2, the electrical storage devices 31-33 are charged with currents supplied from their associated charger circuits 61-63, respectively.

When voltage differences dV1-dV3 between the input voltage Vin and the respective voltages V1-V3 at the first to third electrical storage devices 31-33 become equal to or less than the second preset value E2 (if the answer is YES in ST15, if the answer is YES in ST17, and if the answer is YES in ST19 in FIG. 8), the charger circuits 61-63 finish charging the first to third electrical storage devices 31-33 (in ST16, ST18, and ST20 shown in FIG. 8). More specifically, the charging control unit 8 derives the voltage differences dV1-dV3 at predetermined intervals (of 1 second, for example). At a point in time when the voltage differences dV1-dV3 become equal to or less than the second preset value E2, the charging control unit 8 instructs the first to third charger circuits 61-63 to finish charging the first to third electrical storage devices 31-33, respectively, by controlling the ON/OFF states of the switches S11-S18. In this first variation, the second preset value E2 is set at three different values E21-E23 for the first to third electrical storage devices 31-33, respectively. Alternatively, the second preset value E2 may also be set at the same value for these electrical storage devices.

In this first variation, supposing the second preset value E21 associated with the first electrical storage device 31 is 7.2 V (i.e., E21=7.2 V) and Vin=12V, for example, when the voltage V1 becomes equal to or higher than 4.8 V, the voltage difference dV1 becomes equal to or less than 7.2 V, and the first charger circuit 61 finishes charging the first electrical storage device 31. Specifically, when the switch S15 is controlled OFF by the charging control unit 8, the first charger circuit 61 stops supplying the current to the first electrical storage device 31 to finish charging the first electrical storage device 31. In the same way, supposing the second preset value E22 associated with the second electrical storage device 32 is 4.8 V (i.e., E22=4.8 V), for example, when the voltage V2 becomes equal to or higher than 7.2 V, the voltage difference dV2 becomes equal to or less than 4.8 V, and the second charger circuit 62 finishes charging the second electrical storage device 32. Specifically, when at least one of the switch S11 or the switch S16 is controlled OFF by the charging control unit 8, the second charger circuit 62 finishes charging the second electrical storage device 32. Meanwhile, supposing the second preset value E23 associated with the third electrical storage device 33 is 2.4 V (i.e., E23=2.4 V), for example, when the voltage V3 becomes equal to or higher than 9.6 V, the voltage difference dV3 becomes equal to or less than 2.4 V, and the third charger circuit 63 finishes charging the third electrical storage device 33. Specifically, when the switch S12 is controlled OFF by the charging control unit 8, the third charger circuit 63 finishes charging the third electrical storage device 33. Note that when dV3 becomes equal to or less than 2.4 V in the third connection mode M3, the third charger circuit 63 finishes charging the third electrical storage device 33 during the third connection mode M3.

### (4) Second Variation

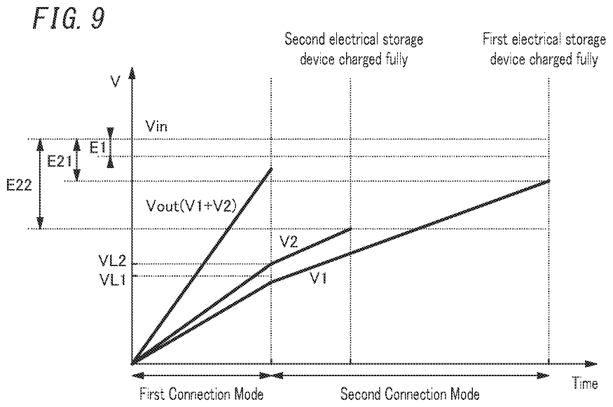

Next, an electrical storage device control system 1 according to a second variation of the exemplary embodiment will be described with reference to FIG. 9. In the following description, any constituent element of this second variation, having the same function as a counterpart of the electrical storage device control system 1 according to the exemplary embodiment described above, will be designated by the same reference numeral as that counterpart's, and description thereof will be omitted herein as appropriate. Optionally, the respective constituent elements of the second variation to be described below may be adopted as appropriate in combination with respective constituent elements described for the exemplary embodiment and the first variation.

In the electrical storage device control system 1 according to the exemplary embodiment described above, a switch between the first connection mode M1 and the second connection mode M2 is made depending on the voltage difference dV between the input voltage Vin for the main power supply 4 and the charging voltage Vout based on the voltages V1 and V2 at the plurality of (two) electrical storage devices 3 (namely, the first electrical storage device 31 and the second electrical storage device 32).

On the other hand, in this second variation, a switch between the first connection mode M1 and the second connection mode M2 is made depending on not only the voltage difference dV between the input voltage Vin and the charging voltage Vout but also the voltages V1 and V2 at the plurality of (two) electrical storage devices 3 (namely, the first electrical storage device 31 and the second electrical storage device 32), which is a difference from the exemplary embodiment and the first variation described above. This difference will be described in further detail.

According to this second variation, a preset voltage VL1 and a preset voltage VL2 are defined in advance for the voltages V1 and V2 at the first electrical storage device 31 and the second electrical storage device 32, respectively. The mode of connection M0 is switched from the first connection mode M1 to the second connection mode M2 when the voltage difference dV between the input voltage Vin and the charging voltage Vout becomes equal to or less than the first preset value E1, or when the voltage V1 becomes equal to or higher than the preset voltage VL1, or when the voltage V2 becomes equal to or higher than the preset voltage VL2. For example, even if the voltage difference dV between the input voltage Vin and the charging voltage Vout (V1+V2) is greater than the first preset value E1, the mode of connection M0 is switched from the first connection mode M1 to the second connection mode M2 when the voltage V2 reaches the preset voltage VL2 as shown in FIG. 9.

In other words, according to this second variation, if the voltage difference dV is greater than the first preset value E1 and the voltages V1 and V2 are lower than the preset voltages VL1 and VL2, respectively, then the first charger circuit 61 and the second charger circuit 62 continue charging in the first connection mode M1.

On the other hand, the first charger circuit 61 and the second charger circuit 62 start charging in the second connection mode M2 when the voltage difference dV becomes equal to or less than the first preset value E1, or when the voltage V1 becomes higher than the preset voltage VL1, or when the voltage V2 becomes higher than the preset voltage VL2.

### (5) Other Variations

Next, other variations of the exemplary embodiment will be enumerated one after another. Note that the variations to be described below may be adopted in combination as appropriate.

The electrical storage device control system 1 according to the present disclosure includes a computer system. The computer system may include a processor and a memory as principal hardware components thereof. The functions of the electrical storage device control system 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the electrical storage device control system 1 are integrated together in a single housing. However, this is not an essential configuration for the electrical storage device control system 1. Alternatively, those constituent elements of the electrical storage device control system 1 may be distributed in multiple different housings. Still alternatively, at least some functions of the electrical storage device control system 1 (e.g., the function of the charging control unit 8) may be implemented as a cloud computing system as well.

In the foregoing description of the exemplary embodiment, if one of two values being compared with each other such as the voltage of the electrical storage device 3 and a preset value is “equal to or less than” the other, the phrase “equal to or less than” may also be a synonym of the phrase “less than.” That is to say, it is arbitrarily changeable, depending on selection of a threshold value or any preset value, whether or not the phrase “equal to or less than” covers the situation where the two values are equal to each other. Therefore, from a technical point of view, there is no difference between the phrase “equal to or less than” and the phrase “less than.” Similarly, the phrase “equal to or greater than” may be a synonym of the phrase “greater than” as well.

### (6) Recapitulation

As can be seen from the foregoing description, an electrical storage device control system (1) according to a first aspect includes a plurality of electrical storage devices (3) and a plurality of charger circuits (6). The plurality of electrical storage devices (3) are charged by a main power supply (4). The plurality of charger circuits (6) are connected between the main power supply (4) and the plurality of electrical storage devices (3). A mode of connection (M0) between the plurality of electrical storage devices (3) being charged is switched to either a first connection mode (M1) or a second connection mode (M2), depending on a voltage difference between an input voltage (Vin) for the main power supply (4) and a charging voltage (Vout) based on respective voltages at the plurality of electrical storage devices (3). In the first connection mode (M1), the plurality of electrical storage devices (3) are connected together in series. In the second connection mode (M2), the plurality of electrical storage devices (3) are connected in parallel to the main power supply (4).

This aspect enables cutting down energy loss involved while the plurality of electrical storage devices (3) are being charged.

In an electrical storage device control system (1) according to a second aspect, which may be implemented in conjunction with the first aspect, the mode of connection (M0) is switched to either the first connection mode (M1) or the second connection mode (M2), depending on not only the voltage difference between the input voltage (Vin) for the main power supply (4) and the charging voltage (Vout) based on the respective voltages at the plurality of electrical storage devices (3) but also respective voltages at the plurality of electrical storage devices (3).

This aspect enables cutting down energy loss involved while the plurality of electrical storage devices (3) are being charged.

In an electrical storage device control system (1) according to a third aspect, which may be implemented in conjunction with the first or second aspect, the plurality of charger circuits (6) are connected in parallel between the main power supply (4) and the plurality of electrical storage devices (3) in the first connection mode (M1). The plurality of electrical storage devices (3) in the first connection mode (M1) are respectively charged with currents supplied from the plurality of charger circuits (6).

This aspect allows the plurality of electrical storage devices (3) to be charged at a higher rate than in a situation where the electrical storage devices (3) are charged by a single charger circuit (6).

In an electrical storage device control system (1) according to a fourth aspect, which may be implemented in conjunction with the first or second aspect, the plurality of charger circuits (6) are provided one to one for the plurality of electrical storage devices (3), respectively. In the second connection mode (M2), each of the plurality of electrical storage devices (3) is charged with a current supplied from an associated one of the plurality of charger circuits (6).

This aspect allows each of the plurality of electrical storage devices (3) to be supplied with a current having an appropriate value.

In an electrical storage device control system (1) according to a fifth aspect, which may be implemented in conjunction with any one of the first to fourth aspects, respective charging periods of the plurality of electrical storage devices (3) overlap with each other at least partially.

This aspect allows the plurality of electrical storage devices (3) to be charged simultaneously, thus shortening the charging time compared to charging the respective electrical storage devices (3) sequentially.

In an electrical storage device control system (1) according to a sixth aspect, which may be implemented in conjunction with any one of the first to fifth aspects, the plurality of charger circuits (6) starts charging the plurality of electrical storage devices (3) in the first connection mode (M1). The plurality of charger circuits (6) starts charging in the second connection mode (M2) when a voltage difference between the input voltage (Vin) and the charging voltage (Vout) becomes equal to or less than a first preset value (E1). The charging voltage (Vout) is a composite voltage of the respective voltages at the plurality of electrical storage devices (3). The plurality of charger circuits (6) finishes charging when the voltage differences between the input voltage (Vin) and the respective voltages at the plurality of electrical storage devices (3) become equal to or less than a second preset value (E2).

This aspect enables controlling charging the plurality of electrical storage devices (3) based on the input voltage (Vin) and the respective voltages at the plurality of electrical storage devices (3).

In an electrical storage device control system (1) according to a seventh aspect, which may be implemented in conjunction with any one of the first to sixth aspects, when power is to be supplied to a load (5), the mode of connection (M0) is switched to the first connection mode (M1) to supply power from the plurality of electrical storage devices (3) to the load (5).

This aspect allows a composite voltage of respective voltages at the plurality of electrical storage devices (3) to be applied to the load (5).

In an electrical storage device control system (1) according to an eighth aspect, which may be implemented in conjunction with any one of the first to seventh aspects, the modes of connection (M0) further include a third connection mode (M3) in which two or more electrical storage devices (3), belonging to the plurality of electrical storage devices (3), are connected together in series. The mode of connection (M0) is switched from the first connection mode (M1) to the third connection mode (M3) and then to the second connection mode (M2).

This aspect enables cutting down energy loss involved while the plurality of electrical storage devices (3) are being charged.

In an electrical storage device control system (1) according to a ninth aspect, which may be implemented in conjunction with the eighth aspect, in the third connection mode (M3), two or more charger circuits (6), belonging to the plurality of charger circuits (6), are connected in parallel. The two or more electrical storage devices (3) are respectively charged with currents supplied from the two or more charger circuits (6). Remaining electrical storage devices (3), other than the two or more electrical storage devices (3), out of the plurality of electrical storage devices (3) are respectively charged with currents supplied from remaining charger circuits (6), other than the two or more charger circuits (6), out of the plurality of charger circuits (6).

This aspect allows two or more electrical storage devices (3) to be charged more rapidly than in a situation where the two or more electrical storage devices (3) are charged by a single charger circuit (6).

In an electrical storage device control system (1) according to a tenth aspect, which may be implemented in conjunction with any one of the first to ninth aspects, the plurality of charger circuits (6) includes a dropper circuit.

This aspect allows the plurality of charger circuits (6) to supply a current, of which the current value is equal to or less than a predetermined current value.

A backup power supply system (2) according to an eleventh aspect includes the electrical storage device control system (1) according to any one of the first to tenth aspects and the main power supply (4).

This aspect enables cutting down energy loss involved while the plurality of electrical storage devices (3) are being charged.

Note that the constituent elements according to the second to tenth aspects are not essential constituent elements for the electrical storage device control system (1) but may be omitted as appropriate.

### REFERENCE SIGNS LIST

1 Electrical Storage Device Control System
2 Backup Power Supply System
3 Electrical Storage Device
4 Main Power Supply
5 Load
6 Charger Circuit
E1 First Preset Value
E2 Second Preset Value
M0 Mode of Connection
M1 First Connection Mode
M2 Second Connection Mode
M3 Third Connection Mode
Vin Input Voltage
Vout Charging Voltage

1. An electrical storage device control system comprising:
a plurality of electrical storage devices to be charged by a main power supply; and
a plurality of charger circuits connected between the main power supply and the plurality of electrical storage devices,
a mode of connection between the plurality of electrical storage devices being charged being switched to either a first connection mode or a second connection mode, depending on a voltage difference between an input voltage for the main power supply and a charging voltage based on respective voltages at the plurality of electrical storage devices,
the first connection mode being a mode of connection in which the plurality of electrical storage devices are connected together in series,
the second connection mode being a mode of connection in which the plurality of electrical storage devices are connected in parallel to the main power supply.

2. The electrical storage device control system of claim 1, wherein
the mode of connection is switched to either the first connection mode or the second connection mode, depending on not only the voltage difference between the input voltage for the main power supply and the charging voltage based on the respective voltages at the plurality of electrical storage devices but also respective voltages at the plurality of electrical storage devices.

3. The electrical storage device control system of claim 1, wherein
the plurality of charger circuits are connected in parallel between the main power supply and the plurality of electrical storage devices in the first connection mode, and
the plurality of electrical storage devices in the first connection mode are respectively charged with currents supplied from the plurality of charger circuits.

4. The electrical storage device control system of claim 1, wherein
the plurality of charger circuits are provided one to one for the plurality of electrical storage devices, respectively, and
in the second connection mode, each of the plurality of electrical storage devices is charged with a current supplied from an associated one of the plurality of charger circuits.

5. The electrical storage device control system of claim 1, wherein
in the second connection mode, respective charging periods of the plurality of electrical storage devices overlap with each other at least partially.

6. The electrical storage device control system of claim 1, wherein
the plurality of charger circuits is configured to start charging the plurality of electrical storage devices in the first connection mode,
the plurality of charger circuits is configured to start charging in the second connection mode when a voltage difference between the input voltage and the charging voltage becomes equal to or less than a first preset value, the charging voltage being a composite voltage of the respective voltages at the plurality of electrical storage devices, and
the plurality of charger circuits is configured to finish charging when the voltage differences between the input voltage and the respective voltages at the plurality of electrical storage devices become equal to or less than a second preset value.

7. The electrical storage device control system of claim 1, wherein
when power is to be supplied to a load, the mode of connection is switched to the first connection mode to supply power from the plurality of electrical storage devices to the load.

8. The electrical storage device control system of claim 1, wherein
the mode of connection is further switched to a third connection mode in which two or more electrical storage devices, belonging to the plurality of electrical storage devices, are connected together in series, and
the mode of connection is switched from the first connection mode to the third connection mode and then to the second connection mode.

9. The electrical storage device control system of claim 8, wherein
in the third connection mode,
two or more charger circuits, belonging to the plurality of charger circuits, are connected in parallel,
the two or more electrical storage devices are respectively charged with currents supplied from the two or more charger circuits, and
remaining electrical storage devices, other than the two or more electrical storage devices, out of the plurality of electrical storage devices are respectively charged with currents supplied from remaining charger circuits, other than the two or more charger circuits, out of the plurality of charger circuits.

10. The electrical storage device control system of claim 1, wherein
the plurality of charger circuits includes a dropper circuit.

11. A backup power supply system comprising:
the electrical storage device control system of claim 1; and
the main power supply.

12. The electrical storage device control system of claim 2, wherein
the plurality of charger circuits are connected in parallel between the main power supply and the plurality of electrical storage devices in the first connection mode, and
the plurality of electrical storage devices in the first connection mode are respectively charged with currents supplied from the plurality of charger circuits.

13. The electrical storage device control system of claim 2, wherein
the plurality of charger circuits are provided one to one for the plurality of electrical storage devices, respectively, and
in the second connection mode, each of the plurality of electrical storage devices is charged with a current supplied from an associated one of the plurality of charger circuits.

14. The electrical storage device control system of claim 2, wherein
in the second connection mode, respective charging periods of the plurality of electrical storage devices overlap with each other at least partially.

15. The electrical storage device control system of claim 3, wherein
in the second connection mode, respective charging periods of the plurality of electrical storage devices overlap with each other at least partially.

16. The electrical storage device control system of claim 4, wherein
in the second connection mode, respective charging periods of the plurality of electrical storage devices overlap with each other at least partially.

17. The electrical storage device control system of claim 2, wherein
the plurality of charger circuits is configured to start charging the plurality of electrical storage devices in the first connection mode,
the plurality of charger circuits is configured to start charging in the second connection mode when a voltage difference between the input voltage and the charging voltage becomes equal to or less than a first preset value, the charging voltage being a composite voltage of the respective voltages at the plurality of electrical storage devices, and
the plurality of charger circuits is configured to finish charging when the voltage differences between the input voltage and the respective voltages at the plurality of electrical storage devices become equal to or less than a second preset value.

18. The electrical storage device control system of claim 3, wherein
the plurality of charger circuits is configured to start charging the plurality of electrical storage devices in the first connection mode,
the plurality of charger circuits is configured to start charging in the second connection mode when a voltage difference between the input voltage and the charging voltage becomes equal to or less than a first preset value, the charging voltage being a composite voltage of the respective voltages at the plurality of electrical storage devices, and
the plurality of charger circuits is configured to finish charging when the voltage differences between the input voltage and the respective voltages at the plurality of electrical storage devices become equal to or less than a second preset value.

19. The electrical storage device control system of claim 4, wherein
the plurality of charger circuits is configured to start charging the plurality of electrical storage devices in the first connection mode,
the plurality of charger circuits is configured to start charging in the second connection mode when a voltage difference between the input voltage and the charging voltage becomes equal to or less than a first preset value, the charging voltage being a composite voltage of the respective voltages at the plurality of electrical storage devices, and
the plurality of charger circuits is configured to finish charging when the voltage differences between the input voltage and the respective voltages at the plurality of electrical storage devices become equal to or less than a second preset value.

20. The electrical storage device control system of claim 5, wherein
the plurality of charger circuits is configured to start charging the plurality of electrical storage devices in the first connection mode,
the plurality of charger circuits is configured to start charging in the second connection mode when a voltage difference between the input voltage and the charging voltage becomes equal to or less than a first preset value, the charging voltage being a composite voltage of the respective voltages at the plurality of electrical storage devices, and
the plurality of charger circuits is configured to finish charging when the voltage differences between the input voltage and the respective voltages at the plurality of electrical storage devices become equal to or less than a second preset value.
